(19) United States
(12) Patent Application Publication
(10) Pub. No.: US 2011/0088969 A1
(43) Pub. Date: Apr. 21, 2011

(54) HEIGHT SAFETY SYSTEM

(75) Inventors: Peter Payne, New South Wales (AU); Mark Elkins, New South Wales (AU)

(73) Assignee: SAFETY COMPLIANCE DESIGN AND SERVICES PTY LTD, Kotara South (AU)

(21) Appl. No.: 12/919,517

(22) PCT Filed: Feb. 27, 2009
(86) PCT No.: PCT/AU2009/000233

§ 371 Date: Dec. 6, 2010

(30) Foreign Application Priority Data
Feb. 28, 2008 (AU) 2008900959
Jun. 5, 2008 (AU) 2008902831
Aug. 14, 2008 (AU) 2008904149

(51) Int. Cl. E06C 7/18; A62B 35/00

(52) U.S. Cl. 182/8; 182/3

(57) ABSTRACT

A height safety system is disclosed for use with an elevated work area including: an elongate member; first and second attachment means; the first attachment means is adapted to restrain the member in use at a lower region of the mast; the second attachment means is adapted to restrain the member in use at about the height of the elevated work area; and a fall restraint device which is adapted to be attached to the member in use at an upper region of the mast.

### TECHNICAL FIELD

The present invention relates to a height safety system and more particularly to a height safety system for use when working on an elevated work area.

### BACKGROUND TO THE INVENTION

When working in elevated work areas, such as on roofs or the like, there is a significant risk of injury to workmen by falling. Various systems have been devised to guard against falling such as systems of rails provided about roofs, or by use of fall restraint systems which include a tether which attaches to a harness worn by the worker, and also attaches to the apex of a roof. However, these systems are not suitable for working on elevated work areas where rails cannot be fitted, or where the roof is flat and has no apex. Accordingly, there is a continuing need for further alternative height safety systems that can be used in relation to broader ranges of work areas.

### SUMMARY OF THE INVENTION

In a first aspect the present invention provides a height safety system for use with an elevated work area including: an elongate member; first and second attachment means; the first attachment means is adapted to restrain the member in use at a lower region of the mast; the second attachment means is adapted to restrain the member in use at about the height of the elevated work area; and a fall restraint device which is adapted to be attached to the member in use at an upper region of the mast.

The first attachment means may include at least one tying device.

The first attachment means may include two tying devices.

The second attachment means may include at least one tying device.

The second attachment means may include two tying devices.

Either of the first or second attachment means may include a lug or a rotatable keeper.

The elongate member may be in the form of a number of interconnected modules.

Adjacent modules may be joined by an insert which is received in end regions of adjacent modules.

The insert may be formed from thermoplastic.

The elongate member may be provided with a number of rungs or steps to enable a person to climb the elongate member.

The height safety system may further include an anchor point for attaching the fall restraint device.

The height safety system may further include a ground engaging portion that is hingedly connected to a lower region of the elongate member.

The ground engaging portion may have a region of high friction material provided on its underside.

In a second aspect the present invention provides a method of providing a height safety system at an elevated work area including the steps of: providing an elongate member and positioning the member in relation to the work area so that an upper region of the elongate member overhangs the work area; restraining the member in relation to the work area at a lower region of the member; restraining the member in relation to the work area at a region of the member which is at about the height of the work area; and attaching a fall restraint device at an upper region of the member.

The method may further include the step of restraining the member at its lower region by at least one tying device.

The tying device may meet the member at an angle of about 90 degrees to the length of the mast.

The method may further include the step of restraining the member at about the height of the work platform by at least one tying device.

The elongate member may be restrained by either of a lug or a rotatable keeper.

The fall restraint device may be attached to the member by way of an anchor point.

The elongate member may be provided in modular form.

The elongate member may be positioned so that the length of the mast extends at about 70 degrees to the horizontal.

### BRIEF DESCRIPTION OF THE DRAWINGS

Embodiments of the present invention will now be described, by way of example only, with reference to the accompanying drawings, in which:

FIG. 1 is a side view of a height safety system according to an embodiment the invention shown in conjunction with an elevated work area;

FIG. 2 is a top view of the height safety system of FIG. 1;

FIG. 3 is a detailed view of the base module of FIG. 1;

FIG. 4 is a detailed view of the climbing module of FIG. 1;

FIG. 5 is a detailed view of the non-climbing module of FIG. 1;

FIG. 6 is a detailed view of the apex module of FIG. 1;

FIG. 7 shows an alternative arrangement for joining mast modules;

FIG. 8 is a cross sectional view through the joining arrangement of FIG. 7; and

FIG. 9 shows an alternative version of an anchor point;

FIG. 10 is a top view of an alternative embodiment of a climbing module illustrating an alternative type of insert for joining modules;

FIG. 11 shows an alternative embodiment of an apex module; and

FIGS. 12 and 13 show an alternative embodiment of a height safety system.

### DETAILED DESCRIPTION OF THE PREFERRED EMBODIMENT

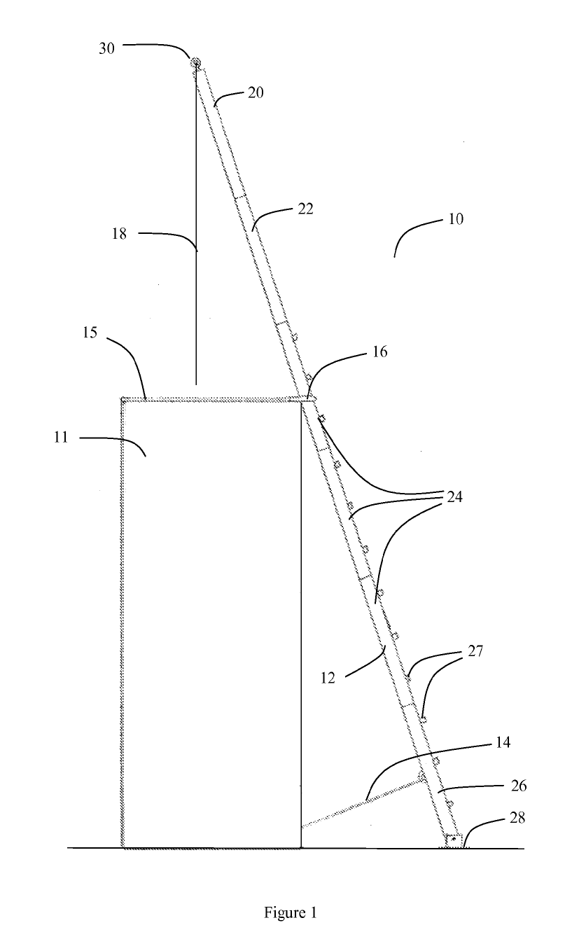

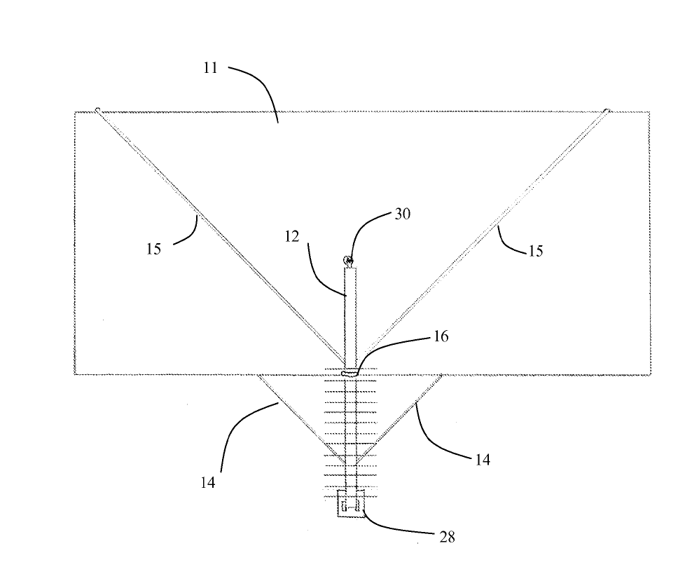

Referring to FIGS. 1 and 2, a height safety system 10 is shown in use in conjunction with an elevated work area, being on top of the roof of a train carriage 11 which is shown in schematic form. The system includes an elongate member in the form of mast 12. A first attachment means includes two tying devices in the form of 12 mm kemmantle restraint lines 14 which restrain the mast 12 at a lower region of the mast. A second attachment means also includes two tying devices in the form 12 mm kemmantle restraint lines 15 which restrain the mast 12 at about the height of the elevated work area. The lower restraint lines 14 attach to a fixed anchor point on the mast 12 and are tied at about ground level at the base of the train carriage 11. The upper restraint lines 15 attach to a 100 mm manulink 16 which fits about mast 12 at the height of the roof of train carriage 11 and are passed over top of the carriage and down to the ground on the far side of the carriage 11 to be tied at about ground level. Each of the restraint lines 14, 15 are provided with a rope grab and karabiner (not shown) for tensioning the lines.

Referring to FIG. 1, it can be seen that the restraint lines 14 meet the mast at an angle of approximately 90 degrees to the length of the mast. Referring to FIG. 2, it can be seen that the restrain lines 14 and 15 diverge from a centre line of the mast on either side by approximately 45 degrees.

Mast 12 is in the form of a number of interconnected modules including apex module 20, non-climbing module 22, climbing modules 24, and base module 26. The climbing modules 24 and base module 26 are each provided with a number of spaced apart rungs 27 to allow a person to climb the mast 12. A fall restraint system in the form of an 11 mm nylon layered fall restraint line 18 is attached to the top of mast 12 by way of anchor point 30.

The base module 26 includes a ground engaging portion in the form of base plate 28 which is hingedly connected to the mast 12 by way of a pivot pin. The underside of base plate 28 is provided with a layer of high friction material in the form of a 2 mm thick layer of non-slip insertion rubber.

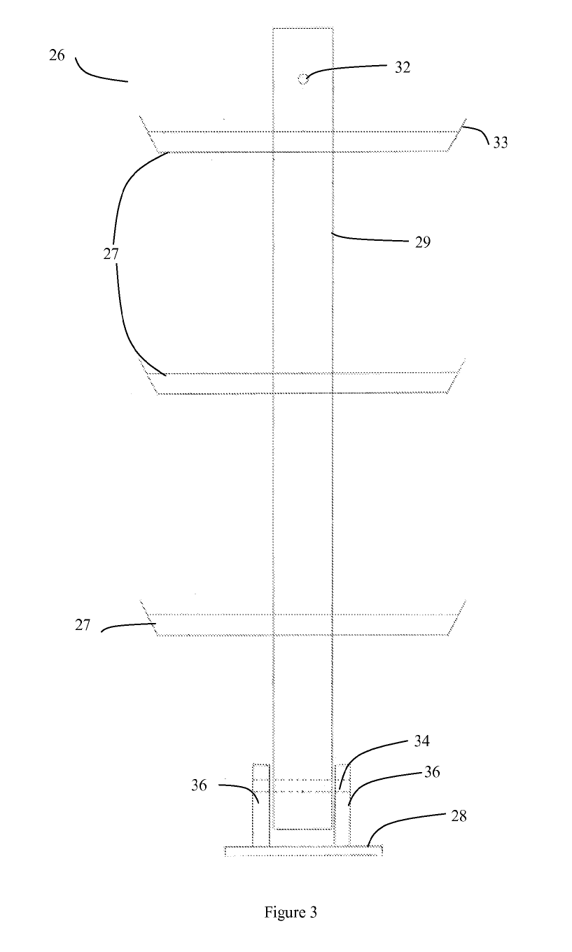

Referring to FIGS. 3 to 6, the various modules which make up the mast are shown in greater detail. In each figure, like components are indicated by like reference numerals.

Referring to FIG. 3, base module 26 is shown in greater detail. It is formed from a 75 mm square tube section 29 of 1.5 mm thick mild steel and of approximately 1050 mm in length. Three steel rungs 27 are spaced along the length of the module and are attached by a welded joint. Each rung 27 is formed from a piece of 25 mm square tube and is approximately 400 mm in length. The rungs have end faces cut at 60 degrees, and at the end of each rung a steel anti-slip lug 33 is welded into place to prevent a person's foot from slipping sideways off the rung.

Base plate 28 includes two upstanding plates 36 with holes drilled though to correspond with a hole drilled through tube section 29. A hinge pin 36 passes through these holes to hingedly connect base plate 28 with tube section 29. A hole 32 is drilled through tube section 29 which receives a locking pin to secure the module to an adjoining module.

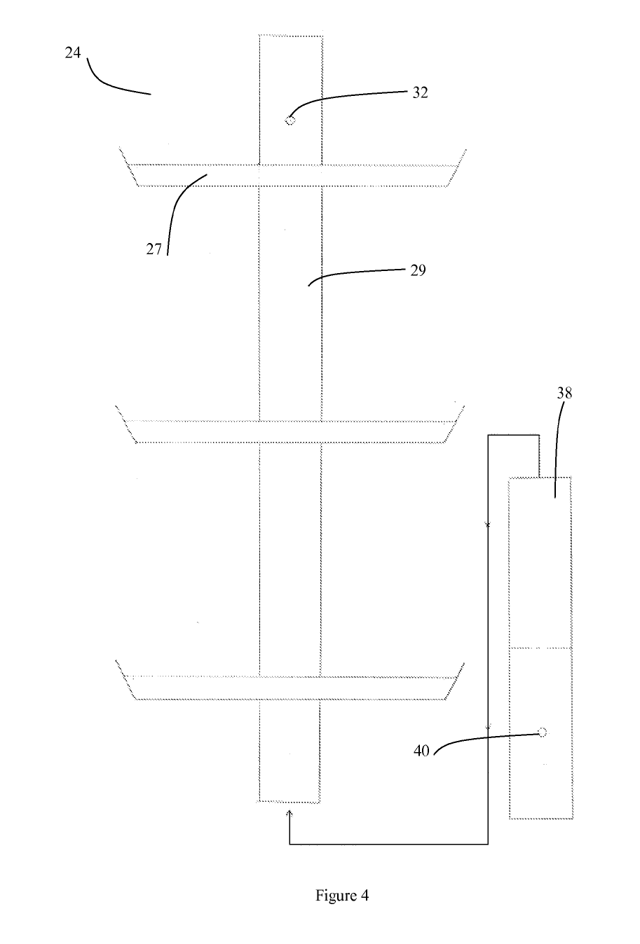

Referring to FIG. 4, climbing module 24 is shown in more detail. The module is formed from a length of steel tube 29 of approximately 900 mm in length. Rungs 27 are welded to tube 29. A 400 mm long square tube insert 38, a snug fit inside tube 29, is inserted to a depth of 200 mm into the bottom end of tube section 29 and welded in place. A 6 mm hole 40 is drilled in the exposed section of tube section 38. This hole corresponds with hole 32 provided in the top of each module. A securing pin is inserted through both sets of holes to secure the modules together in use.

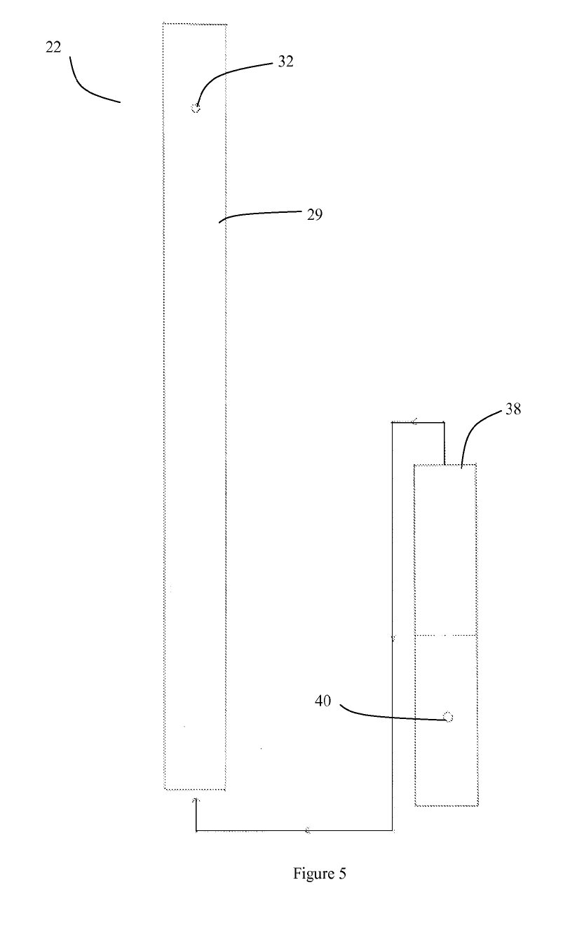

Referring to FIG. 5, non-climbing module 22 is shown in more detail. The module is formed from a 900 mm length of tube 29. Again, an insert 38 is provided at the lower end and securing holes 32, 40 are provided.

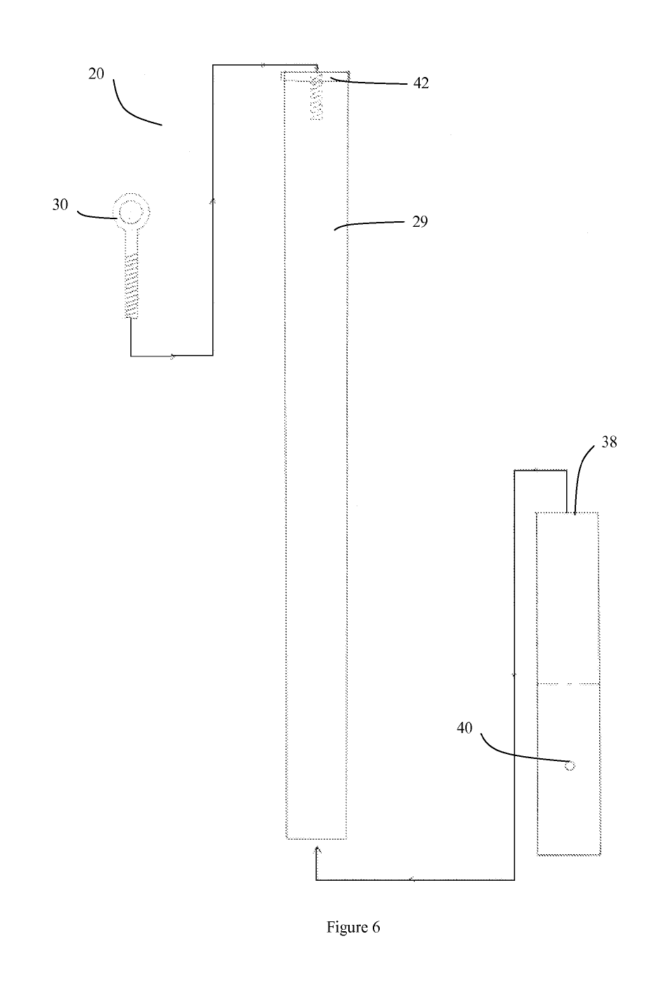

Referring to FIG. 6, apex module 20 is shown in more detail. The module is formed from a length of tube 29 900 mm long. Insert 38 is provided at the lower end of tube 29. An end cap 42 is fitted to the upper end of tube 29 and bears a screw thread to attach anchor point 30. Anchor point may freely rotate through 360 degrees.

The method of installing the system is as follows:
1. The approximate height of the elevated work area is determined
2. The desired height of mast above the work area is determined taking into account that the higher the apex point is above the work area the greater the safe coverage area increases, but the pendulum effect if a fall occurs will also increase. Examples of the diameter of safe work areas are shown in the following table:

| Apex height above | Diameter of safe |
|---|---|
| work platform | work area |
| 2 m | 2.3 m |
| 3 m | 3.4 m |
| 4 m | 4.5 m |
| 5 m | 5.7 m |
| 6 m | 6.8 m |

3. The mast modules are assembled together beginning at ground level to provide the predetermined height. The base module 26 is positioned first. Then the required number of climbing modules 24 are added to extend up to the height of the work platform. Then the required number of non-climbing modules 22 are added and finally the apex module 20.
4. The fall restraint line 18 is attached to the anchor point 30.
5. The manulink 16 is fitted about mast 12 between two rungs at about the height of the elevated work area. The rungs 27 prevent the manulink 16 from sliding up or down the mast 12.
6. The mast is raised up on its base and is rested against the elevated work area at a slope of about 3:1. Thus, the mast meets the ground at an angle of about 70 degrees.
7. The upper restraint lines 15 are run out at 45 degree angles to the right and left of the mast 12 and passed over the work area and down the far side to attach to fixed anchor points at the base of the work area.
8. The lower restraint lines 14 are run out at 45 degree angles to the right and left of the mast 12. The lines 14 are then attached to anchor points at the base of the work area and all restraint lines 14, 15 are tightened by way of the adjustable rope grab devices to take up the slack in the lines.
9. An operator puts on a harness and connects the fall restraint line 18 to the harness by way of a fall arrest device known as an altochute. The altochute allows for the fall restraint line to move through it whilst climbing up or down. It automatically locks onto the line 18 if a fall occurs. Alternatively, a type 2 inertia reel may be used in place of a fall restraint line and altochute. This allows for automatic line deployment and retrieval whilst giving fall arrest security.

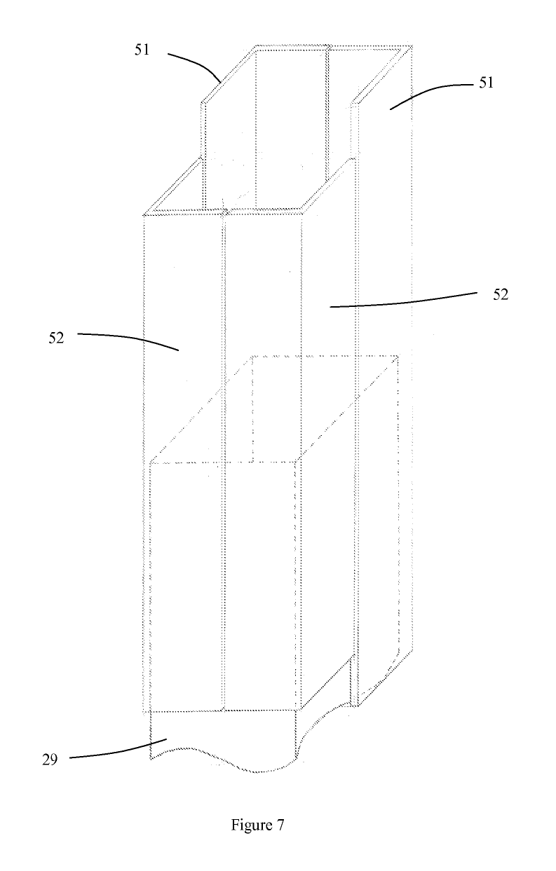

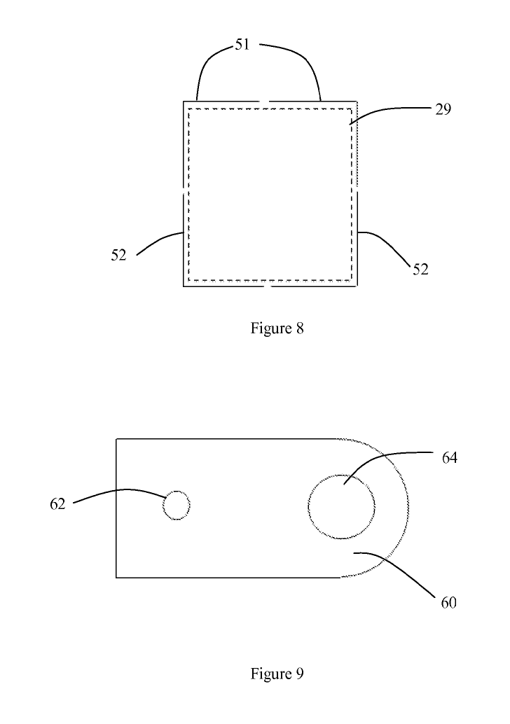

In the embodiment described above, adjacent modules were interconnected by way of a square tube insert 38 which was a snug fit inside the end of the modules. Referring to FIGS. 7 and 8, in other embodiments, the square tube insert may be replaced by an alternative joining arrangement formed from four angle iron sections which are welded about the outside of the end of the tube section 29 and extend beyond the end of tube 29 to thereby form a rectangular sleeve into which an adjacent module is inserted. The angle iron sections are provided in pairs. The rearwardly disposed pair 51 are of dimensions 40 mm×40 mm×6 mm×300 mm. The front pair 52 are of dimensions 40 mm×40 mm×6 mm×250 mm. The sections 51, 52 are welded to tube 29 so that their midpoints lie at the join between two adjacent tubes 29. The 2 mm gaps between the angle sections are welded together, and a hole 40 (not shown) is drilled through the angle iron sleeve to receive a locking pin as before.

In the embodiment described above, anchor point 30 was provided as a threaded insert. Referring to FIG. 9, an alternative version of anchor point is shown in the form of swivel anchor 60. Anchor 60 is formed from a length of mild steel bar 80 mm×150 mm×6 mm. A 12 mm hole 62 is provided at one end, and a 50 mm hole 64 at the other end which is rounded with a 40 mm radius. This version is fitted to top plate 42 prior to fitting of end cap 42 to the apex tube section 29. A 12 mm bolt is passed through hole 62, then through a 12.5 mm washer, and then through the hole in end cap 42. Two nuts are then secured to the bolt so that the anchor 60 is free to rotate. The nuts are spot welded in place to prevent loosening. The top plate 42 is then welded to the end of apex section 29 as before.

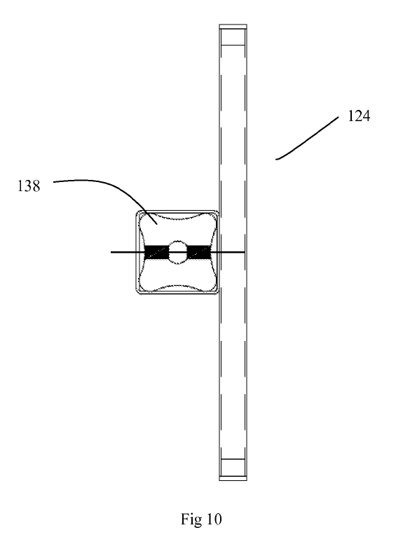

Referring to FIG. 10, an alternative embodiment of a climbing module 124 is shown from above. In this embodiment, an insert 138 is sued which is formed from thermoplastic. The insert 138 is shown in cross section and is 400 mm in length. The insert is milled from a block of thermoplastic to be an interference fit inside mast sections. The block is 70 mm square in cross section and is 200 mm in length. Insert includes bevelled edges at each corner and recesses on each of its four faces to resist the insert 138 from becoming wedged inside mast modules. Further, there are 4 mm bevelled edges (not shown) about the ends of the insert to allow for easy starting for the interference fit.

During production of the mast modules, an insert 138 is inserted to a depth of 100 mm at the top of each mast module and then secured in place by a single 10 mm bolt or screw which is located 50 mm down from the top edge of the mast section.

During assembly of the mast, modules are joined one on top of the other so that the next upper mast section is then slid down onto the exposed 100 mm portion of the thermoplastic insert 138. It is temporarily secured in place by inserting a 10 mm locking pin (passed through from the front edge to the back) with a safety clip. The 10 mm locking pin is located 50 mm up from the bottom edge of the upper mast section.

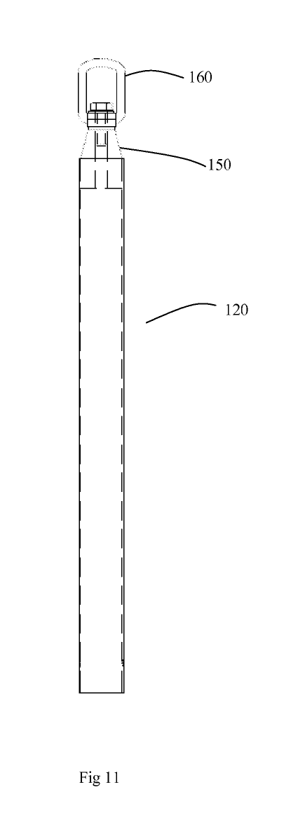

Referring to FIG. 11, an alternative embodiment of an apex section 120 is shown. This embodiment differs to those previously described in the manner of fabricating the anchor point. In this embodiment, a rectangular block of aluminium is machined to provide an adaptor 150 which is square at its base, and conical in its upper portion. A hole is drilled through the adaptor and tapped with a screw thread. The square base of adaptor 150 is inserted into the mast section and welded in place. A Rud Lug® is affixed by way of a bolt to the threaded hole in the adaptor. The Rud Lug serves as an anchor point for the height safety system. It is free to swivel and rotate, and the conical portion of the adaptor 150 ensures that the safety line does not foul on the upper end of the mast as, in use, a worker moves about the work area and causes movement of the Rud Lug. Rud Lugs are available from RUD Chains Pty Ltd (www.rud.com.au). The Rud Lug may be unfastened to perform routine safety inspections of the threaded portions as may be required by local regulations.

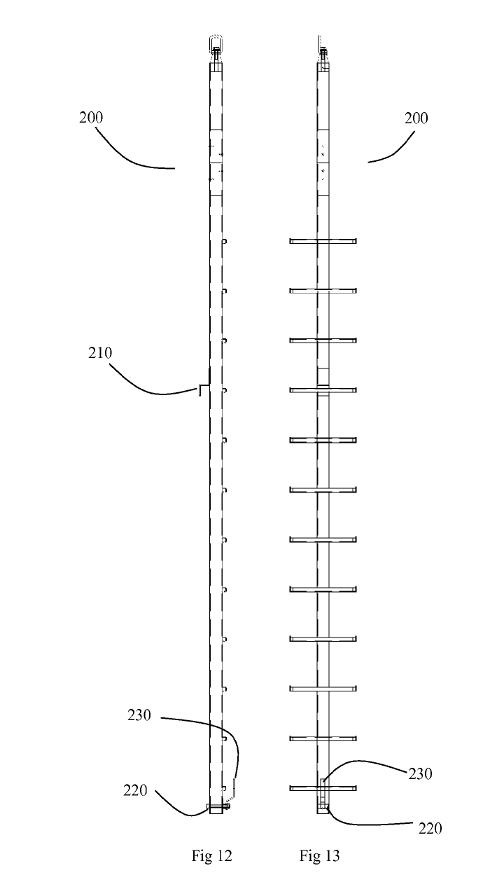

Referring to FIGS. 12 and 13, a further embodiment of a height safety system is shown in the form of mast 200 which is intended for use in conjunction with shipping containers. Standard shipping containers have a “twist lock” fitting at each corner which are used in the handling and securing of the containers during transportation. Mast 200 includes a first attachment means in the form of lug 210 and a second attachment means in the form of a rotatable keeper 220 which is operated by rotating handle 230 through 90 degrees. The distance between lug 210 and keeper 220 corresponds with the height of a standardised shipping container. Lug 210 may be moved between one or more positions along the mast 200 to accommodate shipping containers of various heights.

To deploy mast 200, the lug 210 is engaged with the twist lock fitting on an upper corner of the shipping container and the mast is oriented vertically against the outer wall of the container. The keeper is thus adjacent to the lower twist lock fitting on the bottom corner of the shipping container and the apex of the mast extends above the top of the shipping container with the upper surface of the shipping container being at about the level of lug 210. Keeper 220 is inserted into the twist lock fitting and actuated by rotating handle 230 to become trapped in the lower twist lock fitting to secure the mast to the container. A worker is then tethered to the anchor point in the usual manner and they are thus made safe for climbing the mast 200 and moving about and performing work on top of the shipping container.

It can be seen that embodiments of the invention provide a portable, robust, easily set up system that allows safe access and egress to an elevated work area as well as allowing work to be performed safely whilst in the work area.

Whilst the embodiment above was described with reference to working on top of a railway carriage, the invention has application to other types of elevated work areas including on top of trucks, elevated platforms within mines, other areas on fixed structures such as on top of buildings and the like.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A height safety system for use with an elevated work area including:
an elongate member;
first and second attachment means; the first attachment means is adapted to restrain the member in use at a lower region of the mast; the second attachment means is adapted to restrain the member in use at about the height of the elevated work area; and
a fall restraint device which is adapted to be attached to the member in use at an upper region of the mast.

2. A height safety system according to claim 1 wherein the first attachment means includes at least one tying device.

3. A height safety system according to claim 2 wherein the first attachment means includes two tying devices.

4. A height safety system according to claim 1 wherein the second attachment means includes at least one tying device.

5. A height safety system according to claim 4 wherein the second attachment means includes two tying devices.

6. A height safety system according to claim 1 wherein either of the first or second attachment means includes a lug or a rotatable keeper.

7. A height safety system according to claim 1 wherein the elongate member is in the form of a number of interconnected modules.

8. A height safety system according to claim 7 wherein adjacent modules are joined by an insert which is received in end regions of adjacent modules.

9. A height safety system according to claim 8 wherein the insert is formed from thermoplastic.

10. A height safety system according to claim 1 wherein the elongate member is provided with a number of rungs or steps to enable a person to climb the elongate member.

11. A height safety system according to claim 1 further including an anchor point for attaching the fall restraint device.

12. A height safety system according to claim 1 further including a ground engaging portion that is hingedly connected to a lower region of the elongate member.

13. A height safety system according to claim 12 wherein the ground engaging portion has a region of high friction material provided on its underside.

14. A method of providing a height safety system at an elevated work area including the steps of:
providing an elongate member and positioning the member in relation to the work area so that an upper region of the elongate member overhangs the work area;
restraining the member in relation to the work area at a lower region of the member;
restraining the member in relation to the work area at a region of the member which is at about the height of the work area; and
attaching a fall restraint device at an upper region of the member.

15. A method according to claim 14 further including the step of restraining the elongate member at its lower region by at least one tying device.

16. A method according to claim 15 wherein the tying device meets the elongate member at an angle of about 90 degrees to the length of the mast.

17. A method according to claim 14 further including the step of restraining the elongate member at about the height of the work platform by at least one tying device.

18. A method according to claim 14 wherein the elongate member is restrained by either of a lug or a rotatable keeper.

19. A method according to claim 14 wherein the fall restraint device is attached to the member by way of an eyelet.

20. A method according to claim 14 wherein the elongate member is provided in modular form.

21. A method according to claim 14 wherein the mast is positioned so that the length of the mast extends at about 70 degrees to the horizontal.
